(19) United States
(12) Patent Application Publication
(10) Pub. No.: US 2010/0112220 A1
(43) Pub. Date: May 6, 2010

(54) DISPENSE SYSTEM SET-UP AND CHARACTERIZATION

(75) Inventors: Jared L. Hodge, Austin, TX (US); Van Nguyen Truskett, Austin, TX (US); Logan Simpson, Coupland, TX (US); Bharath Thiruvengadachari, Round Rock, TX (US); Stephen C. Johnson, Austin, TX (US); Philip D. Schumaker, Austin, TX (US)

Correspondence Address: MOLECULAR IMPRINTS, PO BOX 81536, AUSTIN, TX, 78708-1536, US

(73) Assignee: MOLECULAR IMPRINTS, INC., Austin, TX (US)

(21) Appl. No.: 12/608,494

(22) Filed: Oct. 29, 2009

Related U.S. Application Data
(60) Provisional application No. 61/110,630, filed on Nov. 3, 2008.
(60) Provisional application No. 61/111,109, filed on Nov. 4, 2008.
(60) Provisional application No. 61/144,016, filed on Jan. 12, 2009.

(51) Int. Cl. B05D 5/00

(52) U.S. Cl. 427/256

(57) ABSTRACT

The present application describes methods and systems for setting up and characterizing fluid dispensing systems. The methods and systems characterize the fluid dispensing systems and associate the characterizations with the corresponding fluid dispensing systems.

### CROSS RELATION

This application claims priority to U.S. Provisional Patent U.S. Provisional Patent Application No. 61/110,630 filed Nov. 3, 2008; U.S. Provisional Patent Application No. 61/111,109 filed Nov. 4, 2008; and U.S. Provisional Patent No. 61/144,016 filed Jan. 12, 2009; all of which are hereby incorporated by reference herein.

### BACKGROUND INFORMATION

Nano-fabrication includes the fabrication of very small structures that have features on the order of 100 nanometers or smaller. One application in which nano-fabrication has had a sizeable impact is in the processing of integrated circuits. The semiconductor processing industry continues to strive for larger production yields while increasing the circuits per unit area formed on a substrate, therefore nano-fabrication becomes increasingly important. Nano-fabrication provides greater process control while allowing continued reduction of the minimum feature dimensions of the structures formed. Other areas of development in which nano-fabrication has been employed include biotechnology, optical technology, mechanical systems, and the like.

An exemplary nano-fabrication technique in use today is commonly referred to as imprint lithography. Exemplary imprint lithography processes are described in detail in numerous publications, such as U.S. Patent Application Publication No. 2004/0065976, U.S. Patent Application Publication No. 2004/0065252, and U.S. Pat. No. 6,936,194, all of which are hereby incorporated by reference herein.

An imprint lithography technique disclosed in each of the aforementioned U.S. patent application publications and patent includes formation of a relief pattern in a formable (polymerizable) layer and transferring a pattern corresponding to the relief pattern into an underlying substrate. The substrate may be coupled to a motion stage to obtain a desired positioning to facilitate the patterning process. The patterning process uses a template spaced apart from the substrate and the formable liquid applied between the template and the substrate. The formable liquid is solidified to form a rigid layer that has a pattern conforming to a shape of the surface of the template that contacts the formable liquid. After solidification, the template is separated from the rigid layer such that the template and the substrate are spaced apart. The substrate and the solidified layer are then subjected to additional processes to transfer a relief image into the substrate that corresponds to the pattern in the solidified layer.

### BRIEF DESCRIPTION OF DRAWINGS

So that the present invention may be understood in more detail, a description of embodiments of the invention is provided with reference to the embodiments illustrated in the appended drawings. It is to be noted, however, that the appended drawings illustrate only typical embodiments of the invention, and are therefore not to be considered limiting of the scope.

FIG. 1 illustrates a simplified side view of a lithographic system.

FIG. 2 illustrates a simplified side view of the substrate shown in FIG. 1 having a patterned layer positioned thereon.

FIG. 3 illustrates a simplified side view of a fluid dispensing system.

FIG. 4 illustrates a simplified side view of a defect analysis tool.

FIG. 5 illustrates a perspective view of a dispense fixture.

FIG. 6 illustrates a method for setting-up and characterizing lithographic systems.

FIG. 7 illustrates another method for characterizing lithographic systems.

FIG. 8 illustrates a drop pattern for characterizing the orientation of dispense heads.

FIG. 9 illustrates a 3-drop saw tooth pattern.

FIGS. 10A, 10B, and 10C illustrate a drop pattern for characterizing rotational (theta) orientation of dispense heads as shown without (FIG. 10A) and with (FIG. 10B) dispense head theta.

FIGS. 11A and 11B illustrate a drop pattern for characterizing reverse pass offset affects of dispense head as shown without (FIG. 11A) and with (FIG. 11B) reverse pass offset affects.

FIG. 12 illustrates a drop pattern to characterize lithographic systems with two dispense heads using two passes.

FIG. 13 illustrates a drop pattern to characterize lithographic systems with two dispense heads using four passes.

FIG. 14 illustrates a flow chart of a method for positioning dispense heads adjacent to substrates.

FIG. 15 illustrates a plan view of a substrate having a drop pattern dispensed thereon.

FIG. 16 illustrates a drop pattern selected to characterize lithographic systems.

FIG. 17 illustrates an image of drops on a substrate.

FIG. 18 illustrates a plot diagram of dispense locations captured in the scan shown in FIG. 17.

FIGS. 19A and 19B illustrate a drop pattern and a plot diagram of dispense locations being registered.

FIG. 20 illustrates a portion of a plot diagram of extra, missing, and mis-located drops.

FIG. 21 illustrates a plot diagram of missing drops and extra drops.

FIG. 22 illustrates a plot diagram of drop placement errors.

FIG. 23 illustrates a flow chart of a method for correcting imprint defects within drop patterns.

FIG. 24 illustrates a flow chart of a method for establishing lithographic system performance specifications.

FIG. 25 illustrates a flow chart of a method for evaluating the quality of lithographic systems.

### DETAILED DESCRIPTION

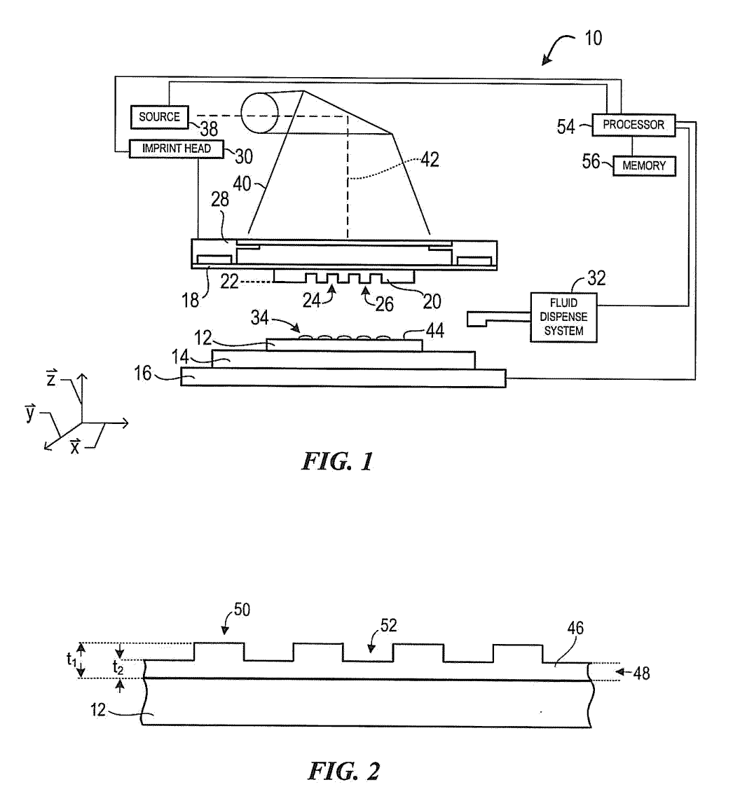

Referring to FIG. 1, illustrated therein is a lithographic system 10 used to form a relief pattern on substrate 12. Substrate 12 may be coupled to substrate chuck 14. As illustrated, substrate chuck 14 is a vacuum chuck. Substrate chuck 14, however, may be any chuck including, but not limited to, vacuum, pin-type, groove-type, electromagnetic, and/or the like. Exemplary chucks are described in U.S. Pat. No. 6,873,087, which is hereby incorporated by reference herein.

Substrate 12 and substrate chuck 14 may be further supported by stage 16. Stage 16 may provide motion along the x-, y-, and z-axes. Stage 16, substrate 12, and substrate chuck 14 may also be positioned on a base (not shown).

Spaced-apart from substrate 12 is a template 18. Template 18 generally includes a mesa 20 extending therefrom towards substrate 12, mesa 20 having a patterning surface 22 thereon. Further, mesa 20 may be referred to as mold 20. Template 18 and/or mold 20 may be formed from such materials including, but not limited to, fused-silica, quartz, silicon, organic polymers, siloxane polymers, borosilicate glass, fluorocarbon polymers, metal, hardened sapphire, and/or the like. As illustrated, patterning surface 22 comprises features defined by a plurality of spaced-apart recesses 24 and/or protrusions 26, though embodiments of the present invention are not limited to such configurations. Patterning surface 22 may define any original pattern that forms the basis of a pattern to be formed on substrate 12.

Template 18 may be coupled to chuck 28. Chuck 28 may be configured as, but not limited to, vacuum, pin-type, groove-type, electromagnetic, and/or other similar chuck types. Exemplary chucks are further described in U.S. Pat. No. 6,873,087, which is hereby incorporated by reference herein. Further, chuck 28 may be coupled to imprint head 30 such that chuck 28 and/or imprint head 30 may be configured to facilitate movement of template 18.

System 10 may further comprise a fluid dispense system 32. Fluid dispense system 32 may be used to deposit polymerizable material 34 on substrate 12. Polymerizable material 34 may be positioned upon substrate 12 using techniques such as drop dispense, spin-coating, dip coating, chemical vapor deposition (CVD), physical vapor deposition (PVD), thin film deposition, thick film deposition, and/or the like. Polymerizable material 34 may be disposed upon substrate 12 before and/or after a desired volume is defined between mold 20 and substrate 12 depending on design considerations. Polymerizable material 34 may comprise a monomer mixture as described in U.S. Pat. No. 7,157,036 and U.S. Patent Application Publication No. 2005/0187339, all of which are hereby incorporated by reference herein.

Referring to FIGS. 1 and 2, system 10 may further comprise an energy source 38 coupled to direct energy 40 along path 42. Imprint head 30 and stage 16 may be configured to position template 18 and substrate 12 in superimposition with path 42. System 10 may be regulated by a processor 54 in communication with stage 16, imprint head 30, fluid dispense system 32, and/or source 38, and may operate on a computer readable program stored in memory 56.

Either imprint head 30, stage 16, or both vary a distance between mold 20 and substrate 12 to define a desired volume therebetween that is filled by polymerizable material 34. For example, imprint head 30 may apply a force to template 18 such that mold 20 contacts polymerizable material 34. After the desired volume is filled with polymerizable material 34, source 38 produces energy 40, e.g., broadband ultraviolet radiation, causing polymerizable material 34 to solidify and/or cross-link conforming to shape of a surface 44 of substrate 12 and patterning surface 22, defining a patterned layer 46 on substrate 12. Patterned layer 46 may comprise a residual layer 48 and a plurality of features shown as protrusions 50 and recessions 52, with protrusions 50 having a thickness t₁ and residual layer 48 having a thickness t₂.

The above-described system and process may be further implemented in imprint lithography processes and systems referred to in U.S. Pat. No. 6,932,934, U.S. Patent Application Publication No. 2004/0124566, U.S. Patent Application Publication No. 2004/0188381, and U.S. Patent Application Publication No. 2004/0211754, each of which is hereby incorporated by reference herein.

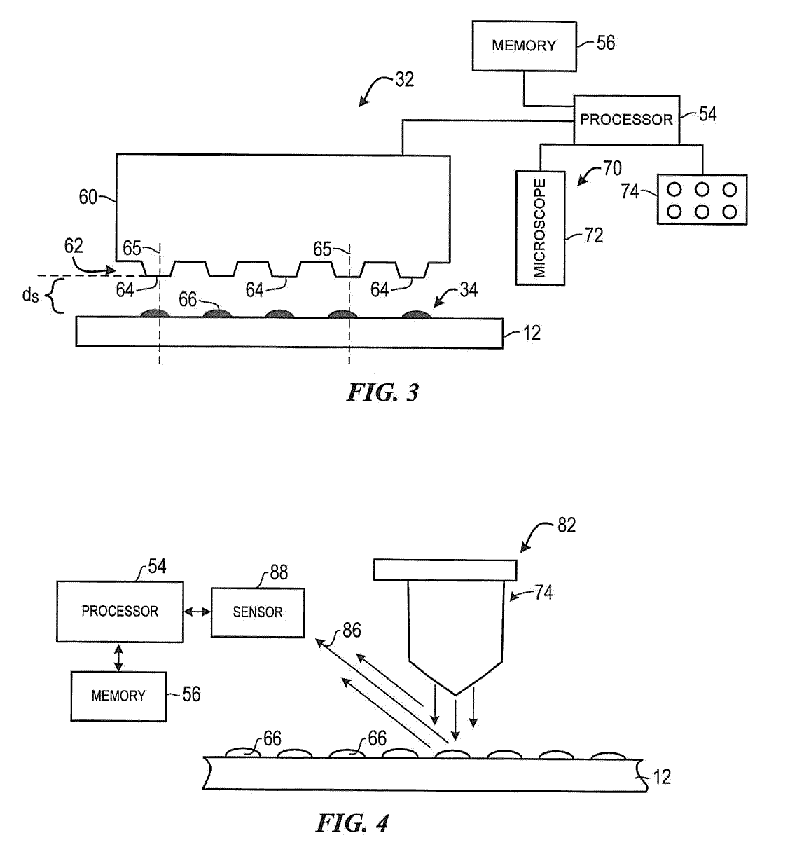

Fluid dispense system 32 may be used to deposit polymerizable material 34 on substrate 12. FIG. 3 illustrates a fluid dispense system 32 comprising a dispense head 60 and a dispense system 62 for depositing polymerizable material 34 on substrate 12. Dispense head 60 may comprise micro-solenoid valves or piezo-actuated dispensers. Piezo-actuated dispensers are commercially available from MicroFab Technologies, Inc., Plano, Tex.

Generally, polymerizable material 34 propagating through dispense head 60 egresses from at least one nozzle 64 of dispense system 62. It should be noted that a single nozzle 64 or multiple nozzles 64 may be used depending on design considerations.

As illustrated in FIG. 3, fluid dispense system 32 may optionally be connected to a vision system 70. Vision system 70 may comprise a microscope 72 (e.g. optical microscope) to provide images 74 of polymerizable material 34 placement on substrate 12. Microscope 72 may be regulated by processor 54, and further may operate on a computer readable program stored in memory 56. Images 74 may be provided at periodic intervals during the imprinting process.

Generally, the as-dispensed drops 66 may be analyzed using defect analysis tools known within the industry and other tools. Exemplary defect analysis tools are further described in U.S. Pat. No. 7,019,835, U.S. Pat. No. 6,871,558, U.S. Pat. No. 7,060,402, and U.S. Patent Publication No. 20070246850, all of which are hereby incorporated by reference herein. FIG. 4 illustrates an exemplary defect analysis tool 82 having one or more energy sources 84 (e.g., light sources) providing energy 86 (e.g., light) focused to impinge on one or more regions of the substrate 12. Energy 86 may be reflected and/or deflected to a sensor 88 (for instance, an optical sensor) to provide for capturing images of the substrate 12. For example, the reflected energy 86 may contain information regarding characteristics such as the film thickness (when a patterned layer is being imaged), the size of the drops (when a drop pattern is being imaged), the location of the drops 66, the size of the drops 66, the shape of the drops 66, and/or the like. The information detected by the sensor 88 may be transmitted to the processor 54. The processor 54 may quantize the received information received from the sensor 88 to information contained in memory 56 (e.g., look-up table) regarding the desired pattern.

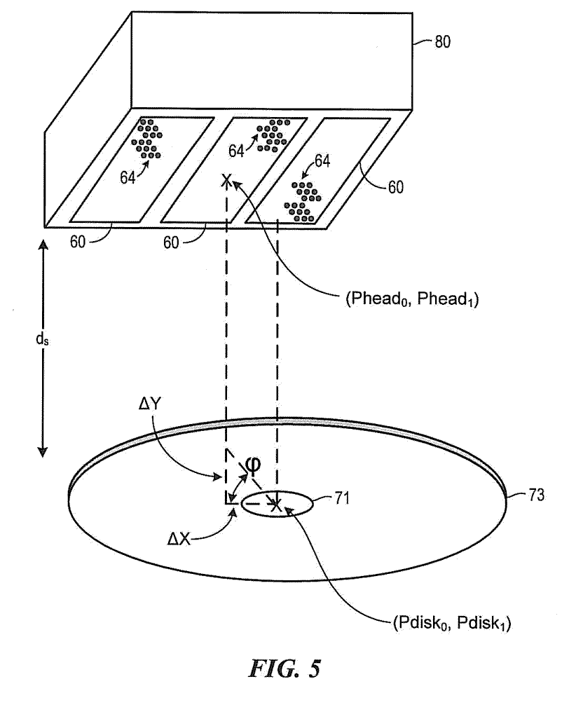

Referring to FIG. 5, illustrated therein is a perspective view of a dispense fixture 80. The dispense fixture 80 holds a plurality of dispense heads 60 each including a plurality of nozzles 64 disposed across the operative surface of the dispense head 60. In some embodiments, the nozzles 64 are disposed in staggered, offset groups of three. These nozzle groupings facilitate dispensing fluid from the individual nozzles 64 by allowing a first subgroup of nozzles 64 to dispense fluid at a first time and a second subgroup, differing from the first subgroup, of nozzles 64 to dispense fluid at a second time. In an embodiment, one nozzle 64 of the group dispenses fluid at one time and the other nozzles 64 of the group dispenses fluid at other times. In some embodiments, the timing is such that no two adjacent nozzles 64 dispense fluid at the same time. Thus, timing between nozzles 64 can be a consideration in the dispensing of fluid from the overall dispense head 60 of some embodiments.

While FIG. 5 illustrates that the dispense fixture 80 includes 3 dispense heads 60, dispense fixtures 80 having fewer or more dispense heads 60 are within the scope of the disclosure. The dispense heads 60 can be from the same, or different manufacturers and/or have the same or different model numbers. However, it is often the case that each dispense head 60 in the dispense fixture 80 is from one manufacturer and of one model number. However, each dispense head 60 typically has associated therewith a serial number which (in conjunction with the manufacturer and model number or standing alone) uniquely identifies the particular dispense head 60. In some embodiments, the serial number and other identifying information can be labeled on the particular dispense heads 60, can be stored in a memory device in the dispense heads 60, or a combination thereof.

Furthermore, each of the dispense heads 60 is positioned in the dispense fixture 80 in a fixed relationship to the dispense fixture 80 and to the other dispense heads 60. Thus, by controlling the dispense heads 60 in the dispense fixture 80 in certain manners, the processor 54 can cause the dispense heads 60 to operate as a single unit in dispensing fluid. Indeed, the processor 54 of many embodiments controls the nozzles 64 of the various dispense heads 60 to dispense a pattern of drops 66.

FIG. 5 also illustrates a substrate 12 (which can be a wafer) in relationship to the dispense fixture 80. Thus, the distance dₛ between the nozzles 64 and the substrate 12 is illustrated by FIG. 5. In addition, any given dispense head 60 has a center (or other reference point) which defines its location in the dispense fixture 80. The substrate 12 also has a center (or other reference point) which defines its location. Since the lithographic system 10 often holds the dispense fixture 80 and substrate 12 in fixed relationship to one another, the centers of the dispense heads 60 and the substrate 12 can be expressed in terms of the same coordinate system by points such as (P_{head0}, P_{head1}) and (P_{disk0}, P_{disk1}) where the illustrative substrate 12 is a disk. Thus an offset or a distance d=SQRT(ΔX²+ΔY²) can exist between the center of any particular dispense head 60 and a particular substrate 12 where ΔX is the x component of offset and ΔY is the y component. Due to manufacturing tolerances, variations in how the various dispense heads 60 mount to the dispense fixture 80, etc., these distances ΔX and ΔY can vary between substrates 12, dispense heads 60, dispense fixtures 80, and/or from time-to-time (for instance, after a particular dispense head 60 is removed and re-installed in the dispense fixture 80). As a result of the variations in the distances ΔX and ΔY, the performance of the lithographic system 10 (see FIG. 1) can vary between the dispensing of one set of drops 66 and the dispensing of another set of drops 66.

Typically, the substrate 12 is a wafer or disc of some material such as silicon or silicon oxide. These discs often have an inner annular region 71 and an outer annular region 73. The chuck 14 can hold the substrate 12 by way of the inner and/or the outer annular regions 71 and 73. As mentioned, in some cases, the substrate 12 may be a silicon wafer with a flattened side (created during its formation) which can be used as a key to aid in positioning and locating the wafer on the chuck 14.

Other sources of variation in the performance of the overall lithographic system 10 arise from a variety of sources. For instance, the performance of the nozzles 64, dispense heads 60, processor 54 (and associated circuitry and software), and fluid components in the lithographic system 10 can vary. Moreover, environmental and other conditions can cause variations in the performance of the lithographic system 10. Thus ambient pressures, temperatures, humidity, etc. and pressures, temperatures, fluids, pressurizing agents, etc. in communication with the nozzles 64 can also cause performance variations of the lithographic system 10. While the users of the lithographic system 10 typically control some or all of the foregoing variables (among many others) it may be desirable to characterize the performance of the lithographic system 10 to account for these sources of performance variations. Moreover, the characterization of the lithographic system 10 can occur during or after its set up, during its operation, etc.

Embodiments disclosed herein provide methods and systems for characterizing lithographic systems. Some of the provided methods include associating a selected pattern (with a selected orientation) of drops with a particular dispense head. In the current embodiment, the selected pattern is selected to characterize the particular dispense head. Each nozzle of that dispense head is controllable to dispense a drop (which has a selected location and size). These methods also include attempting to dispense the selected pattern by controlling the nozzles to dispense a first pattern of drops wherein this first as-dispensed pattern has a first as-dispensed orientation and each as-dispensed drop has a first as-dispensed location and size. Moreover, the methods also include (relative to the selected pattern) characterizing the first as-dispensed pattern. Furthermore, the methods include associating the characterization of the first as-dispensed pattern with the particular dispense head.

As desired, the methods can include a number of other operations such as:
determining the first as-dispensed orientation of the first as dispensed drop pattern relative to the substrate,
determining whether each nozzle dispensed a drop according to how it was controlled during the dispensing of the first as-dispensed pattern,
determining the sizes of the as-dispensed drops,
determining whether any of the as-dispensed locations are farther from the corresponding selected locations by more than a corresponding threshold distance,
determining whether any of the as-dispensed locations (which are farther from the corresponding selected locations by more than the corresponding threshold distances) indicate timing issues between any two or more of the nozzles,
determining whether any two as-dispensed locations indicate the presence of a reverse pass offset greater than a corresponding threshold offset,
determining a position of the particular dispense head relative to a substrate on which the first as-dispensed pattern was dispensed, and/or
determining whether a position of the particular dispense head is farther from a selected position associated with the selected pattern by more than a threshold distance.

Moreover, the methods can include dispensing a second pattern of drops; characterizing a particular fluid dispensing system (of which the particular dispense head is a portion); and associating the characterization of the particular fluid dispensing system with the particular fluid dispensing system and the particular dispense head.

In the alternative, or in addition, the methods can include adjusting the particular dispense head; dispensing a second pattern of drops with the as-adjusted dispense head; characterizing the second as-dispensed pattern; and associating the characterization of the second as-dispensed pattern with the particular dispense head.

The methods can also include developing a plot diagram of a pattern of drops based on a performance specification; dispensing a second pattern of drops on a particular substrate; evaluating the second as-dispensed pattern (relative to the plot diagram); and associating, with the particular dispense head, the evaluation of the second as-dispensed pattern. Moreover, the plot diagram can be used to evaluate the particular dispense head as used with the particular substrate. The evaluation of the second as-dispensed pattern can include correlating the as-dispensed drops with the plot diagram after the second as-dispensed pattern is solidified. In the alternative, or in addition, the performance specification can include a parameter related to the thickness of a residual layer. Thus, the evaluation of the as-dispensed pattern can include correlating the second as-dispensed drop size of at least one drop with that thickness. Furthermore, the substrate can be a wafer on which the second as-dispensed pattern is used to form an imprinted layer.

Another embodiment provides a system for characterizing lithographic systems. The system includes a vision system (for characterizing drop patterns dispensed by the lithographic systems), a processor, and a memory in communication with each other. The memory stores processor executable instructions which when executed by the processor cause the processor to perform one or more of the foregoing methods for characterizing lithographic systems using the vision system, the processor, and the memory. Optionally, the dispense heads can be a portion of a nano-lithography system or any other type of fluid dispensing system. For instance, the fluid dispensing system could be used with logical, pharmaceutical, semi-conductor, etc. types of fluids. The system can include, if desired, a graphic user interface for displaying data and/or information related to the characterization of the image of the first as-dispensed pattern.

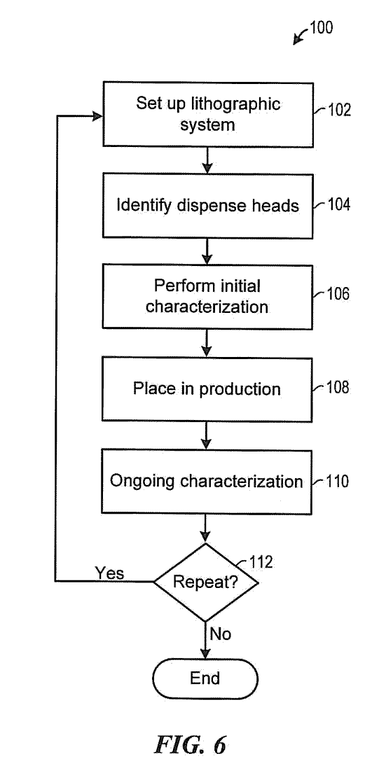

Referring now to FIG. 6, illustrated therein is a method for characterizing a lithographic system 10. The illustrative method 100 includes certain operations 102, 104, 106, 108, and 110 such as operation 102 in which the lithographic system 10 is set up. The set-up of the lithographic system 10 includes fixedly mounting one or more dispensing heads 60 to the dispense fixture 80 (thereby placing the nozzles 64 in fluid communication with the fluid in the fluid dispense system 32), selecting and placing the substrate 12 in the chuck 14, selecting a fluid to be dispensed, filling the lithographic system 10 with that fluid, and setting pressures, temperatures, etc. in the fluid dispense system 32, etc. See operation 102. Moreover, identifying data regarding the dispense heads 60 (and other aspects of the lithographic system 10, fluid dispense system 32, and substrate 12) can be recorded. See operation 104.

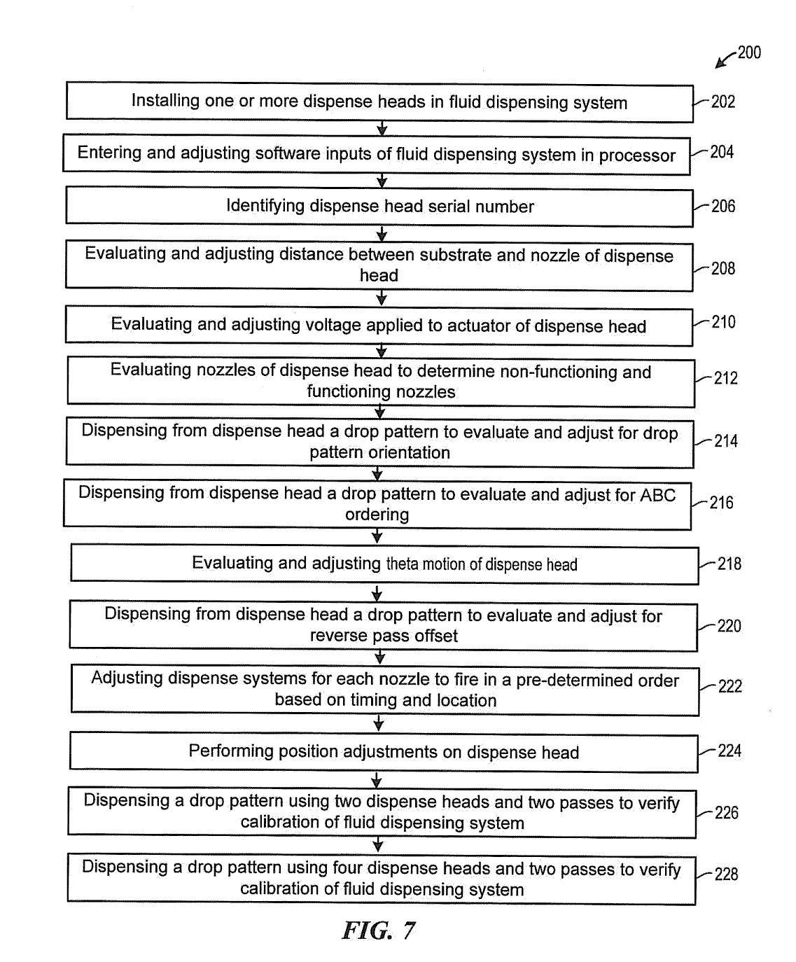

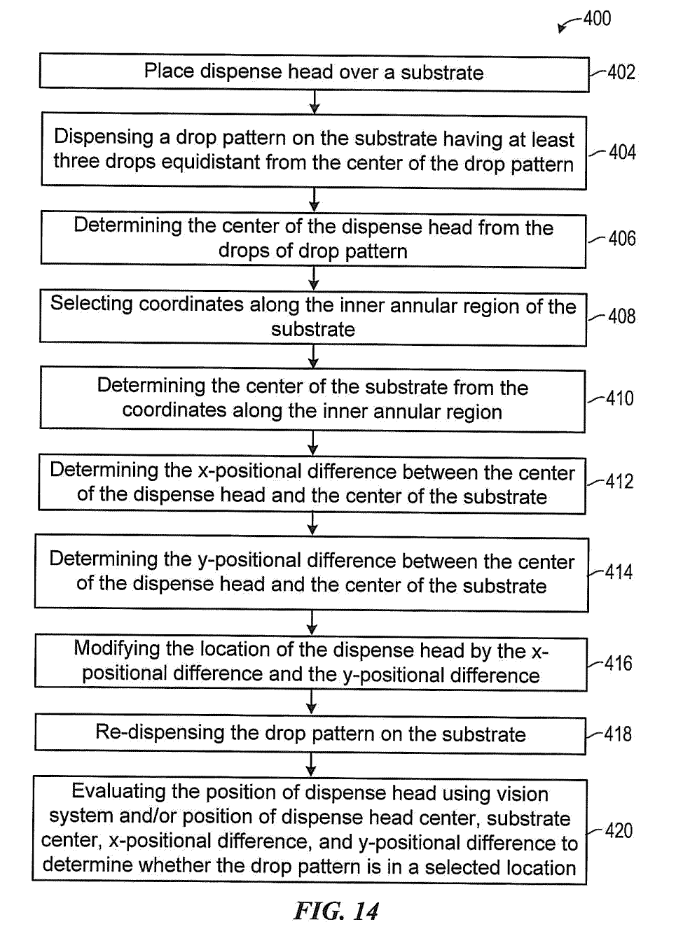

The initial characterization of the lithographic system 10 includes some or all of the operations illustrated by, and disclosed, with reference to FIGS. 7-15 (although other operations could be included). See operation 106. While, operation 106 is referred to as an initial characterization of the lithographic system 10, it is understood that operation 106 can occur when desired by the user and is not constrained to be performed only once. Actions such as those discussed with reference to operations 102, 104, and 106 can occur during the initial set up of the lithographic system 10; when the lithographic system 10 is moved or otherwise modified; when the lithographic system is in an operational environment; etc.

Nonetheless, at some time, a user may desire to place the lithographic system 10 in operation as indicated by operation 108. Thus, the lithographic system 10 might be modified in one or more manners to prepare it for operations such as dispensing fluid(s) on various substrates 12. Since performance variations might affect the imprints produced with the lithographic system 10, some lithographic system 10 characterizations can be performed on an ongoing or as-desired basis. See operation 110. For instance, the characterizations of the lithographic system 10 illustrated by operation 110 could occur periodically during production.

With reference again to FIG. 6, operation 112 illustrates that the various portions of method 100 can repeat as desired. For instance, when the user modifies the lithographic system 10 or its use, the method 100 can repeat from operation 102. In other circumstances (for instance, the lithographic system 10 remains in production for some selected number of dispense cycles, some selected time period, etc.) method 100 can repeat from operation 106. Otherwise, the method 100 can end as indicated at operation 112.

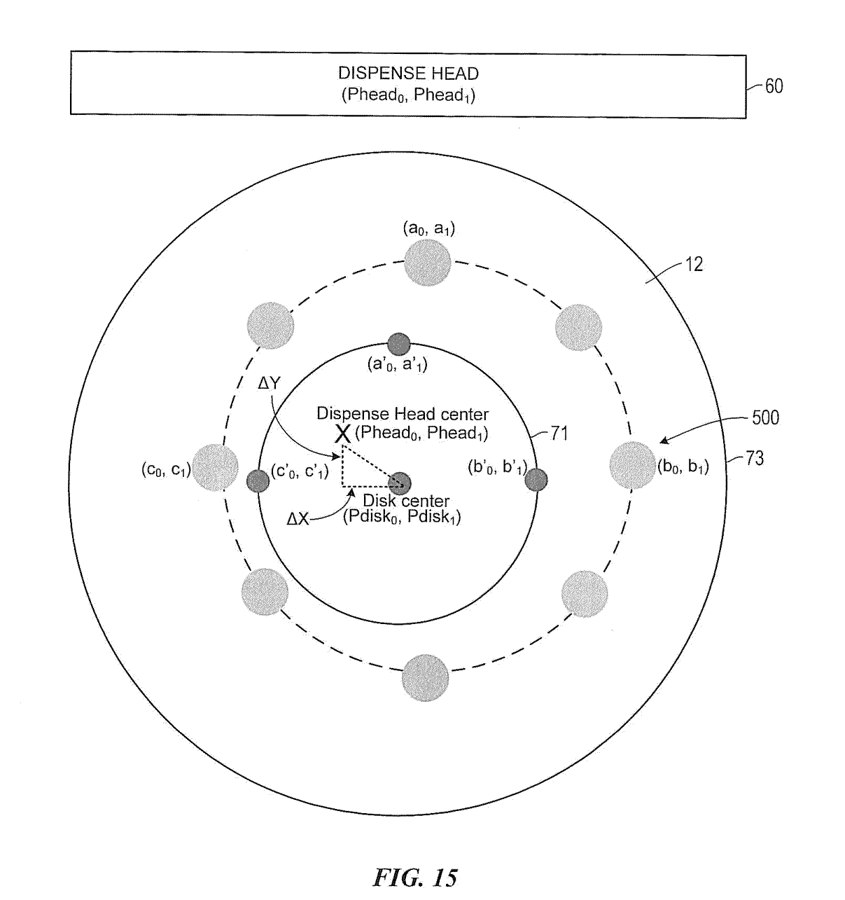

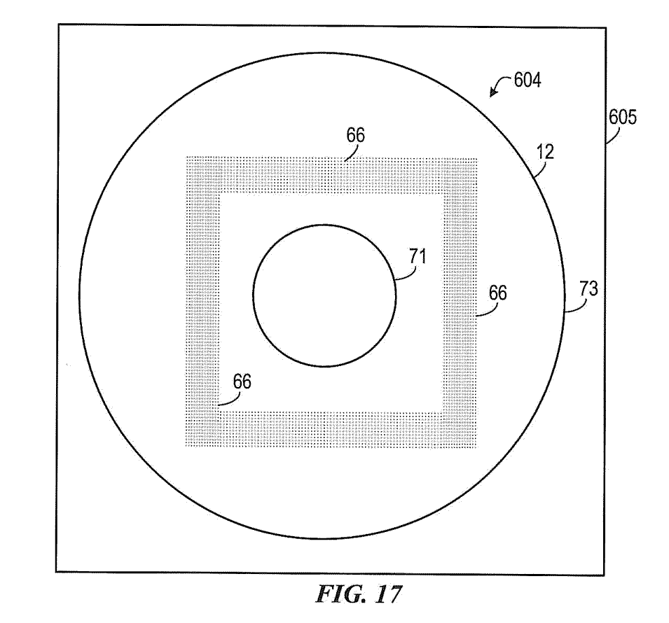

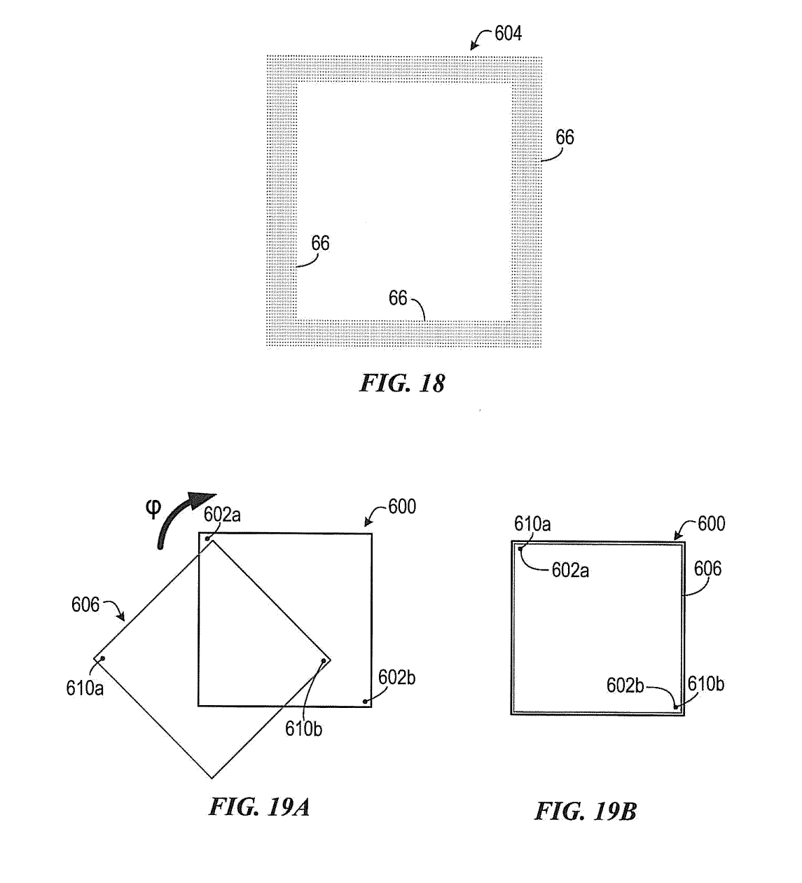

With reference now to FIGS. 7-15, methods of initially characterizing the lithographic system 10 are disclosed (see operation 104). With reference to FIGS. 15-25, methods of characterizing the lithographic system 10 on an as-desired basis are also disclosed herein (see operation 108).

FIG. 7 illustrates a flow chart of a method 200 for characterizing the lithographic system 10 and, more particularly, the fluid dispense system 32. Since the operation of the fluid dispense system 32 can influence the lithographic imprints formed by the lithographic system 10, it may be desirable to gather data regarding the operation of the fluid dispense system 32 and to make adjusts to its operation based on the gathered data Generally, characterization of the fluid dispense system 32 includes software, mechanical, and other adjustments for registering nozzles 64, dispense systems 62, and/or dispense heads 60 to generate a coherent drop pattern using the dispense heads 60. The results obtained (and data pertaining to those results and the performance of the fluid dispense system 32) can be recorded for subsequent use. For instance, once one or more dispense heads 60 are characterized, the characterization data can be used to select dispense heads 60 for various applications, to adjust the operation of the lithographic system 10, and for other purposes.

Thus, with continuing reference to FIG. 7 and in operation 202, one or more dispense heads 60 may be installed in the dispense fixture 80 of the fluid dispense system 32. More particularly, the dispense heads 60 can be installed in the dispense fixture 80 and fixedly aligned with one another therein. In operation 204, initial software inputs related to the dispense heads 60 may be entered and adjusted with processor 54. In operation 206, the serial numbers of the dispense heads 60 may be identified and provided to processor 54. Identifying the print heads 60 with their serial numbers, manufacturers, model numbers and other identifying information allows data gathered during the characterization of the fluid dispense system 32 to be associated with the dispense heads 60 installed therein.

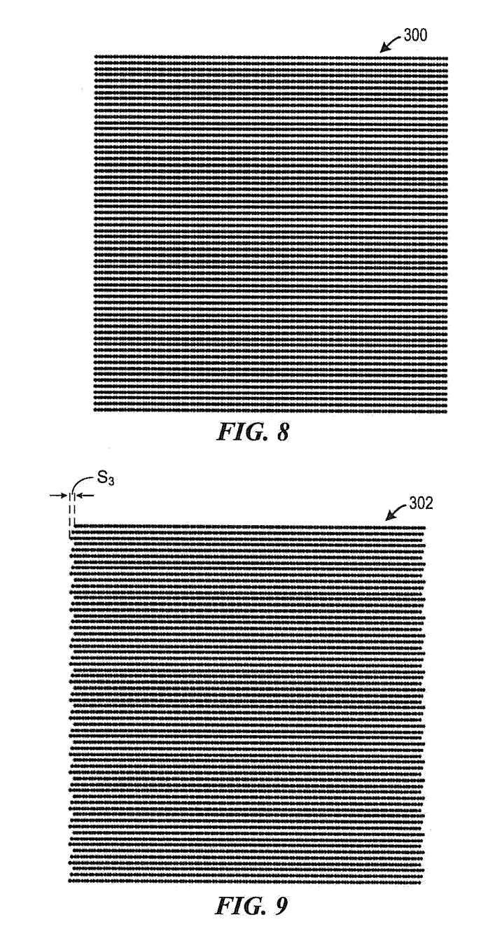

In operation 208, the distance dₛ between the substrate 12 and the nozzles 64 may be evaluated and adjusted to provide the drops 66 to be dispensed on the substrate 12 without smearing or spraying of the drops 66 caused by the nozzles 64 being respectively either too close or too far from the substrate 12. In operation 210, the voltage V applied to the actuator(s) of the dispense head(s) 60 may be evaluated and adjusted to attain the desired drop sizes. In operation 212, the nozzles 64 of the dispense heads 60 may be evaluated for non-functioning and functioning nozzles 64 by determining whether any drops 66 in an as-dispensed drop pattern are missing, duplicated, etc. as compared to a drop pattern selected to verify and/or characterize the operations of the nozzles 64. In operation 214, a drop pattern 300 (shown in FIG. 8) may be dispensed by nozzles 64 to characterize and/or adjust the overall orientation of the drop pattern. See operation 214.

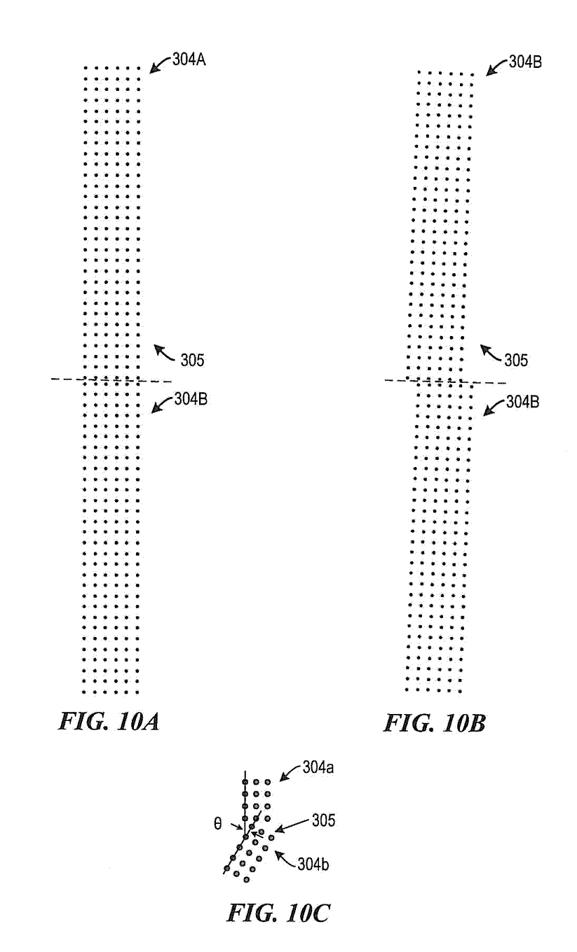

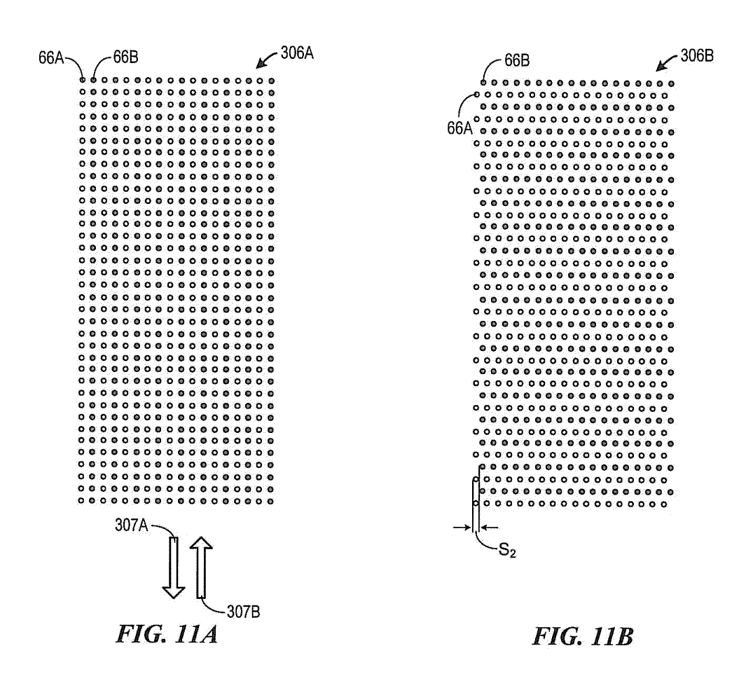

Furthermore, in operation 216, a drop pattern 302 (shown in FIG. 9) may be dispensed to characterize and/or adjust the nozzle firing order. In operation 218, another drop pattern 304 (shown in FIG. 10) may be dispensed by the dispense heads 60 to characterize and/or adjust for any theta motion and/or misalignment of the dispense heads 60. In operation 220, yet another drop pattern 306 (shown in FIG. 11) may be dispensed to characterize and adjust for reverse pass offset affects that might be detectable in the drop pattern 306. In operation 222, and if multiple dispense heads 60 are installed in the fluid dispense system 32, dispense systems 62 (including circuitry associated with delivering a voltage to each of the nozzles 64 in a particular dispense head 60) for each dispense head 60 may be adjusted to fire the nozzles 64 in a pre-determined order based on the location of the nozzles 64 and the affects that the firing order might have on yet to be dispensed patterns.

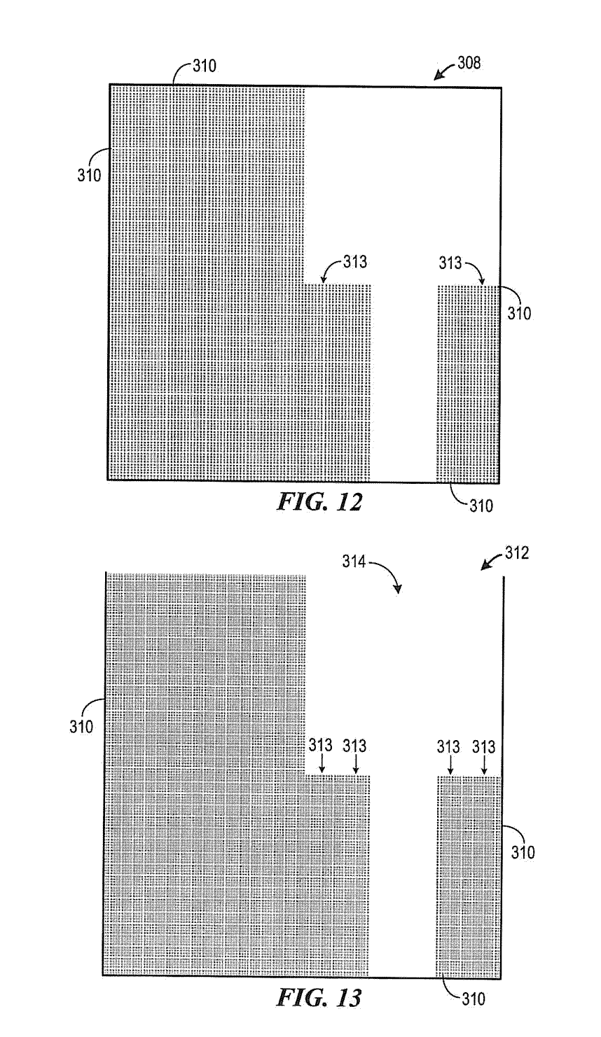

In operation 224, the positions of the dispense heads 60 in the dispense fixture 80 may be adjusted based on the as-dispensed patterns due to possible mis-alignments associated with the dispense heads within the dispense fixture 80. In operation 226, another drop pattern 308 (shown in FIG. 12) may be dispensed with two (or more) of the dispense heads 60 installed in the fluid dispense fixture 80 and with two or more passes of the dispense fixture 80 over (or along) the substrate 12 to characterize the dispense heads 60 as they are installed (and aligned) in the dispense fixture 80. In operation 228, another drop pattern 312 (shown in FIG. 13) may be dispensed using these two dispense heads 60 and using four or more passes to further characterize the as-installed, as-aligned dispense heads 60. While the two pass characterization of operation 226 can reveal some misalignment of the heads 60 between the passes, the four pass characterization of operation 226 is more likely to reveal such pass-to-pass misalignments since the third and fourth pass provide additional opportunities for any misalignment present to evidence itself. This result is so because as the mechanism which drives the stage 16 switches print directions, backlash and other sources of reverse pass offset might accumulate between passes.

In some embodiments, some of the foregoing operations may be omitted or repeated without departing from the scope of the disclosure. Other modifications to method 200 may also be made without departing from the scope of the disclosure. For instance, many of the foregoing operations can be accomplished using one common as-dispensed pattern of drops 66 to characterize many aspects of the lithographic system 10. More information regarding certain of the foregoing operations are disclosed in further detail herein.

### Installation of Dispense Head

For instance and with reference again to operation 202 of method 200 (see FIG. 7), at some time, the fluid dispense system 32 may be set up. Part of the set up can include selecting and installing one or more dispense heads 60 in the dispense fixture 80. The selection of the dispense heads 60 often depends upon the application to which they will be applied. The selected dispense heads 60 may have stitched nozzles 64, interleaved nozzles 64, or other nozzle patterns depending on design, production, and other considerations on which the selection of the dispense heads 60 might bear. Regardless of the type of dispense head(s) selected, the fluid dispense system 32 can be characterized with the selected dispense heads 60 installed in the dispense fixture 80.

### Fluid Dispense System Set-Up

Since each type of dispense head 60 may differ in some aspects, the user may input (into the processor 54) parameters regarding pertinent system settings for the installed dispense heads 60. See operation 204 of method 200. For instance, the gray level volume, the maximum gray level, the gray-scale remap, the nozzle 64 spacing, the number of nozzles 64, the gap between the nozzles 64, the spacing between the dispense heads 60, encoder parameters, stage orientation parameters, nominal dispense head locations, and/or the like may be input into the processor 54.

For example, an encoder used for a particular type of dispense head 60 may have a 0.5 μm frequency after passing through an encoder splitter. The associated equation for print frequency is:

$$\frac{{I}_{p} ⋆ {E}_{d}}{{E}_{m}} = {O}_{p}$$

wherein Iₚ is the input pitch of the encoder (e.g., 0.5 μm), E_{d} is the encoder divide, Eₘ is the encoder multiply, and Oₚ is the output pitch. E_{d} and Eₘ are typically integers. The input pitch Iₚ may be fixed based on the system stage encoder, and the encoder multiply Eₘ and encoder divide E_{d} may be adjusted to provide the output pitch Oₚ equal to the nozzle 64 stagger for the dispense system 62 of the dispense head 60 under consideration. For example, dispense head 60 may include a nozzle stagger of 28.16667. Providing an encoder divide E_{d} of 169 and encoder multiply Eₘ of 3 at an input pitch Iₚ of 0.5 μm may produce an output pitch Oₚ of 28.16667. In another example, providing an encoder divide E_{d} of 56 and encoder multiply Eₘ of 1 at an input pitch Iₚ of approximately 0.5 μm, however, may produce an output pitch Oₚ of 28 μm resulting in pattern shrinkage of 0.16667 every 28.16667 μm or approximately 0.6%. Thus, these parameters as well as others may be input into the processor 54 for some or all of the dispense head 60 installed in the dispense fixture 80 thereby enabling the fluid dispense system 32 to accurately dispense desired drop patterns.

### Identification of Serial Number

With continuing reference to FIG. 7, and operation 206, the dispense heads 60 may be uniquely identified. More particularly, the serial number (and manufacturer and model number) of each dispense head 60 may be input into the processor 54 to enable the processor 54 to associate data regarding the characterization of the fluid dispense system 32 with the dispense heads 60 installed therein during that characterization. The serial number may also provide a unique label for the individual dispense heads 60 when multiple dispense heads 60 are installed in the fluid dispense system 32.

Characterizing and Adjusting the Nozzle-to-Substrate Distance dₛ

With reference now to operation 208, since the distance dₛ (see FIG. 3) between the substrate 12 and the nozzles 64 can affect the quality of the drops dispensed onto the substrate 12, the distance dₛ may be characterized and adjusted. The adjustment may be a mechanical adjustment to the position of the stage 16, the chuck 14, the dispense head(s) 60, the dispense fixture 80, etc. In some embodiments, the distance dₛ between the substrate 12 and the nozzles 64 may be less than approximately 700 microns although other distances are within the scope of the disclosure.

### Characterizing and Adjusting Control Voltage

Moreover, since the voltage V applied to the dispense heads 60 can affect the size of the dispensed drops 66, that voltage V may be adjusted (see operation 210 of FIG. 7). For example, dispense head 60 may be provided an initial voltage V of 17.0 volts. Using the initial voltage, the dispense heads 60 may dispense a pre-determined number of drops 66 so that the resulting drop sizes and/or drop placement fidelity may be determined. For instance, the drop sizes may be determined using the defect analysis tool 82. These as-dispensed drop sizes may be adjusted by increasing or decreasing initial voltage V. Moreover, this process may be repeated until the as-dispensed drop sizes and/or drop 66 placement fidelity is determined to be acceptable to the user.

Moreover, as the drops 66 dispensed by the various nozzles 64 are evaluated for size, it will likely be apparent whether any particular nozzle 64 fails to dispense a drop. Thus, in operation 212 of method 200, the nozzles 64 can be evaluated to determine whether they are functioning.

### Characterizing and Adjusting Dispense Head Orientation

As illustrated in FIG. 8, in operation 214, the drop pattern 300 may be dispensed from the dispense heads 60 to characterize the overall orientation of the various dispense heads 60. Should the as-dispensed orientation of the drop pattern 300 reveal that a dispense head 60 is incorrectly installed (for example, the lines of the drop pattern 300 run in the y direction instead of the x direction as is illustrated), the dispense head 60 can be re-installed or otherwise adjusted to obtain the desired orientation. If desired, the drop pattern 300 can be dispensed again to verify the as-dispensed orientation at operation 214.

### Characterizing and Adjusting Dispense Head Firing Order

Additionally, the same drop pattern 300 may be used or a separate drop pattern may be dispensed to characterize the firing order of the nozzles 64. In some embodiments, the fluid dispense system 32 uses 3-cycle, shared wall, dispense heads 60. Generally, these types of dispense heads 60 have three “cycles” of nozzles 64 in a given row. Nozzles 64 in the A cycle may be aligned along the dispense head 60 in the print head at one location while nozzles 64 in the B cycle may be shifted back ⅓ of the pitch in the print direction from that location. Nozzles 64 in the C cycle may be further shifted back from the location of the A cycle nozzles 64 another ⅓ of the pitch from nozzles 64 in the B cycle. Thus, it may be desirable to have a short delay in time between the firing of the nozzles 64 in the A and B cycles, and another delay in time between the firing of the nozzles 64 in the B and C cycles. Generally, the nozzles 64 of the current embodiment are strictly ABC alternating although other arrangements are within the scope of the disclosure. As such, in the current embodiment, no two adjacent nozzles 64 fire simultaneously. Accordingly, depending on the print direction, it may be desirable to fire the nozzles 64 in the order ABC, to fire the nozzles 64 in the order CBA, or in some other order.

The drop pattern 300 may be analyzed to verify that the nozzle firing order is adequate by (for instance) determining whether the as-dispensed drop pattern has a straight edge pattern along an edge running in the y direction (typically desired and indicative of correct firing order) or a 3-drop saw tooth pattern (typically not desired and indicative of a less than optimal firing order). A straight edge drop pattern 300 (along the edges running in the y direction) is illustrated in FIG. 8 and a 3-drop saw tooth pattern 302 is illustrated in FIG. 9. If the dispense system 62 dispenses a 3-drop saw tooth pattern 302, the firing of the nozzles 64 may be adjusted so as to provide the straight edge drop pattern 300 or any other desired drop pattern.

Characterizing and Adjusting Theta Offset and/or Motion

Since, in some lithographic systems 10, relative rotational motion between the substrate 12 and the dispense fixture 80 (see FIG. 5) is possible, it may be desirable to characterize the degree of radial offset between the substrate 12 and the dispense heads 60 in the dispensing fixture. For example, as illustrated in FIG. 10A, dispense system 62 may dispense a drop pattern 304A that can include a drop from every nozzle 64 in a particular row of nozzles 64 in a dispense head 60. That drop pattern 304A may be dispensed as another drop pattern 304B offset by some distance (for instance, 50 mm off) in one direction (for instance, the y-direction) while using the same location in an orthogonal or other direction (for instance the x-direction).

Generally, this may produce a region 305 of overlap between the one as-dispensed pattern 304B and the other as-dispensed pattern 304B. This region 305 may be on the order of a few mms although other degrees of overlap might exist. In the alternative, or in addition, to a lateral offset, a theta offset might evidence itself as a difference in orientation of the two as-dispensed patterns 304A and 304B. FIG. 10A illustrates a situation in which the two as-dispensed drop patterns 304A and 304B align with each other meaning that little or no offset exists. FIG. 10B, though, illustrates a situation in which the two as-dispensed drop patterns 304A and 304B exhibit some degree of misalignment as indicated at θ in FIG. 100 (which may be a few degrees).

The dispense system 62 may then be adjusted until the offset in the selected direction (for instance, the x-direction, y-direction, or the radial offset θ) between the first drop pattern 304A and the second drop pattern 304B is acceptable to the user. The theta offset and/or motion may be adjusted using a picomotor connected to dispense head 60, manually, or otherwise. Additionally, if there is pairing in a direction other than the print direction (for instance the y-direction) wherein two adjacent drops are closer together than expected and that pair is followed by a large gap in that same direction before the next drop 66, the motion of the dispense head 60 may be adjusted to eliminate a potential offset that might be affecting the dispense heads 60. See for instance, operation 218 of method 200. Thus, operation 218 illustrates that the theta offset can be characterized, eliminated, and/or minimized.

### Characterizing and Adjusting for Reverse Pass Offset

As illustrated in FIG. 11A (and at operation 226 of FIG. 7), another drop pattern 306 may be dispensed to determine reverse pass offset affects and to enable their elimination (or minimization) as may be desired. Reverse offset pass typically causes a stagger S between drops 66A of a drop pattern 306 dispensed using passes in one print direction 307A and drops 66B of that drop pattern 306 deposited after the print direction 307B has been reversed. The resulting as-dispensed drop pattern 306 exhibits that stagger S in the print direction (often designated as the x-direction). Thus, the drop pattern used in characterizing the reverse pass offset affect(s) can include single rows of drops 66, each row dispensed one at a time with print directions 307 being reversed between these rows.

More particularly, the edge (running in the y direction) of the drop pattern 306A of FIG. 11A illustrates a drop pattern without such stagger wherein all drops 66 along the edge are aligned. In contrast, drop pattern 306B illustrates the stagger S between alternating drops 66 along the edge of the drop pattern 306B. More specifically, FIG. 11B illustrates a 2-drop repeating stagger S₂ in which alternating rows of drops 66 show the stagger S₂ between themselves. With reference again to FIG. 9, a 3-drop repeating stagger S₃ exhibits itself along the edge (running in the y direction) of the drop pattern 302. The 3-drop repeating stagger S₃ includes offsets between the two successive pairs of drops 66 in any three rows in the drop pattern 302.

Regardless of the type of stagger S exhibited, the stagger S can be compensated for since the space between the drops 66 within the drop pattern 306B (or 302) may be used to estimate the extent or scale of the stagger. Typically, each row of drops 66 may be evaluated separately and the average offset determined. Moreover, stagger S may exist in any direction in the drop pattern 306B. For instance, reverse pass offset affects may cause the drops along the edges of the drop pattern 306B to exhibit a stagger S between adjacent rows of drops. Stagger might therefore occur in either the x direction of the y direction. Regardless of the direction in which the stagger S exhibits itself, the mechanism which drives the stage 16 may be adjusted to eliminate or minimize the stagger S as may be desired.

### Characterizing and Adjusting Dispense Head Position

In some situations, it might be the case that one or more print heads 60 are installed with an offset between their desired position in the dispense fixture 80 and their actual position in the dispense fixture 80. Hence, in such situations, a corresponding offset will likely exist between the actual position of the dispense head 60 and the position of the substrate 12. Accordingly, it may be desirable to characterize the actual position of the dispense heads 60 relative to the substrate 12. Corresponding position adjustments may be performed on dispense head 60 to eliminate or minimize such offsets.

More particularly, if some number of rows (either in the x direction or the y direction) of drops 66 in a drop pattern fail to appear on the substrate 12 (or target area thereof), one or more dispense heads 60 may be offset from its desired position in the dispense fixture 80. While drop rows can be used to measure the offsets, other measures (for instance, the positions of various features which appear or fail to appear in a target area) can be used without departing from the scope of the disclosure. Operation 226 of FIG. 7 illustrates that the positions of various dispense heads 60 can be characterized and corresponding position adjustments to the dispense head 60 can be made.

More particularly, FIGS. 12 and 13 illustrate a situation in which a selected drop pattern 308 includes a two row border 310 of drops 66 around its circumference. In contrast, the as-dispensed drop pattern 312 illustrates that the border 310 exists along only three sides of the as-dispensed drop pattern 312. Along the fourth side, a portion 314 of the border 310 failed to dispense (or was dispensed outside of the target area of the substrate 12). Accordingly, the corresponding dispense head 60 is likely to have been installed with an offset corresponding in magnitude to the missing portion 314 of the as-dispensed drop pattern 312. The affected dispense head 60 may be re-positioned to eliminate or minimize such an offset.

### Two Dispense Heads, Two Pass Characterization and Adjustment

As discussed herein, drop patterns such as drop pattern 308 may be dispensed using multiple dispense heads 60. These multiple dispense heads 60 may make two or more passes over the substrate 12 to dispense drop pattern 308. Drop pattern 308 may be analyzed to determine if affects related to reverse pass offset, dispense head 60 placement, and/or the like might exist in the drop pattern 308. For example, if two drops in drop pattern 308 are close together in the x-direction followed by a large gap before the next drop 66 in the x-direction, then the stage 16 may be adjusted to eliminate or minimize reverse pass offset affects.

### Two Dispense Heads, Four Pass Characterization and Adjustment

As illustrated in FIG. 13, another drop pattern 312 may be dispensed using multiple dispense heads 60. Dispense heads 60 may make four or more passes to provide more sensitivity to the affects of reverse pass offset by allowing more print direction reversals during which the affects of reverse pass offset might accumulate. Drop pattern 312 may be analyzed to determine if the affects of reverse pass offset, dispense head 60 placement, and/or the like exist in the drop pattern 312. As illustrated, drop pattern 312 exhibits more reverse pass offset affects than the drop pattern 308 as shown by the increased number of gaps 313 in the four-pass drop pattern 312 as compared to the two-pass drop pattern 308.

### Dispense Head Location Characterization

FIGS. 5, 14, and 15 illustrate a method 400 for locating a dispense head(s) 60 relative to a substrate 12. More particularly, the center of the dispense head 60 and the center of the substrate 12 may be registered with each other so that drop patterns can be accurately and precisely dispensed onto the substrate 12 by the dispense head 60. In some situations, it might be desirable to center the dispense head 60 over or adjacent to the substrate 12. In the alternative, or in addition, it might be desirable to characterize any offset between the centers of the substrate 12 and the dispense head 60. Moreover, in some situations, it might be desirable to eliminate or minimize the offset.

To characterize the offset between the substrate 12 and the dispense head 60, method 400 can be used. In method 400 the offset can be determined using the geometry of the inner annular region 71 and/or the outer annular region 73 (see FIG. 15) or other points on the substrate 12 with known locations or locations which can be determined. Generally, two or more drops 66 are dispensed onto the substrate 12 and their locations are mathematically compared to two or more points or other known positions on the substrate 12.

Thus, in method 400 at operation 402, the dispense head 60 is placed over the substrate 12 at a distance dₛ deemed satisfactory for dispensing drops 66 onto the substrate 12. In operation 404, the dispense head 60 dispenses a drop pattern 500 on the substrate 12. This drop pattern 500 can include at least two, and in some embodiments, three drops 66 dispensed to be equidistant from the center of the drop pattern 500 of which they are a portion. In some embodiments the drops 66 of drop pattern 500 lay at known distances from some reference point associated with the drop pattern. The coordinates (a₀, a₁), (b₀, b₁), and (c₀, c₁) of these drops 66 may be determined. For instance, the coordinates of these drops may be obtained by moving the stage 16 to center each drop 66 in the image 74 (see FIG. 3) from the microscope 72 and obtaining the stage location or the absolute stage location from instrumentation on the stage 16 (see FIG. 1) or associated therewith. In some embodiments, other methods can be used to determine the drop coordinates.

In operation 406, the center at the coordinates (Phead₀, Phead₁) of the dispense head 60 relative to the substrate 12 is determined from the coordinates of the drops 66 as obtained in operation 404. For instance, the center of the dispense head 60 may be determined by the coordinates of drops (a₀, a₁), (b₀, b₁), and (d₀, d₁) using the following equations:

$$D = 2 ( {a}_{1} {c}_{o} + {b}_{1} {a}_{o} - {b}_{1} {c}_{0} - {a}_{1} {b}_{0} - {c}_{1} {a}_{0} + {c}_{1} {b}_{0} )$$

$${Phead}_{0} = \frac{( \begin{matrix}{b}_{1} {a}_{0}^{2} - {c}_{1} {a}_{0}^{2} - {b}_{1}^{2} {a}_{1} + {c}_{1}^{2} {a}_{1} + {b}_{0}^{2} {c}_{1} + {a}_{1}^{2} {b}_{1} + \\ {c}_{0}^{2} {a}_{1} - {c}_{1}^{2} {b}_{1} - {c}_{0}^{2} {b}_{1} - {b}_{0}^{2} {a}_{1} + {b}_{1}^{2} {c}_{1} - {a}_{1}^{2} {c}_{1}\end{matrix} )}{D}$$

$${Phead}_{1} = \frac{( \begin{matrix}{a}_{0}^{2} {c}_{0} + {a}_{1}^{2} {c}_{0} + {b}_{0}^{2} {a}_{0} - {b}_{0}^{2} {c}_{0} + {b}_{1}^{2} {a}_{0} - {b}_{1}^{2} {c}_{0} - \\ {a}_{0}^{2} {b}_{0} - {a}_{1}^{2} {b}_{0} - {c}_{0}^{2} {a}_{0} + {c}_{0}^{2} {b}_{0} - {c}_{1}^{2} {a}_{0} + {c}_{1}^{2} {b}_{0}\end{matrix} )}{D}$$

In operation 408, the coordinates of two or more locations on the inner annular region 71 of substrate 12 may be obtained. For instance, in FIG. 15, the points having the coordinates (a′₀, a′₁), (b′₀, b′₁), and (c′₀, c′₁) may be selected for use in locating the dispense head 60 relative to the substrate 12. The coordinates of these points may be obtained by centering these points in the image 74 by using the stage 16 and the position instrumentation associated therewith or by other methods.

In operation 410, the coordinates (Pdisk₀, Pdisk₁) of the center of the substrate 12 may be determined from the points selected on the inner annular region 71 (or other points) of substrate 12. For instance, the center (Pdisk₀, Pdisk₁) of the substrate 12 may be determined from the coordinates (a′₀, a′₁), (b′₀, b′₁), and (c′₀, c′₁) of the points on the inner annulus region 71 using the following equations:

$$D = 2 ( {a}_{1}^{′} {c}_{o}^{′} + {b}_{1}^{′} {a}_{o}^{′} - {b}_{1}^{′} {c}_{0}^{′} - {a}_{1}^{′} {b}_{0}^{′} - {c}_{1}^{′} {a}_{0}^{′} + {c}_{1}^{′} {b}_{0}^{′} )$$

$${Pdisk}_{0} = \frac{( \begin{matrix}{b}_{1}^{′} {a}_{0}^{′2} - {c}_{1}^{′} {a}_{0}^{′2} - {b}_{1}^{′2} {a}_{1}^{′} + {c}_{1}^{′2} {a}_{1}^{′} + {b}_{0}^{′2} {c}_{1}^{′} + {a}_{1}^{′2} {b}_{1}^{′} + \\ {c}_{0}^{′2} {a}_{1}^{′} - {c}_{1}^{′2} {b}_{1}^{′} - {c}_{0}^{′2} {b}_{1}^{′} - {b}_{0}^{′2} {a}_{1}^{′} + {b}_{1}^{′2} {c}_{1}^{′} - {a}_{1}^{′2} {c}_{1}^{′}\end{matrix} )}{D}$$

$${Pdisk}_{1} = \frac{( \begin{matrix}{a}_{0}^{′2} {c}_{0}^{′} + {a}_{1}^{′2} {c}_{0}^{′} + {b}_{0}^{′2} {a}_{0}^{′} - {b}_{0}^{′2} {c}_{0}^{′} + {b}_{1}^{′2} {a}_{0}^{′} - {b}_{1}^{′2} {c}_{0}^{′} - \\ {a}_{0}^{′2} {b}_{0}^{′} - {a}_{1}^{′2} {b}_{0}^{′} - {c}_{0}^{′2} {a}_{0}^{′} + {c}_{0}^{′2} {b}_{0}^{′} - {c}_{1}^{′2} {a}_{0}^{′} + {c}_{1}^{′2} {b}_{0}^{′}\end{matrix} )}{D}$$

With continuing reference to FIGS. 5, 14, and 15 and in operation 412, the x-positional difference LX between the center (at coordinates Phead₀, Phead₁) of the dispense head 60 and the center (at coordinates Pdisk₀, Pdisk₁) of the substrate 12 may be determined by subtracting the x-components of the respective locations. In operation 414, the y-positional difference ΔY between the center (Phead₀, Phead₁) of the dispense head 60 and the center (Pdisk₀, Pdisk₁) of the substrate 12 may be determined by subtracting the y-components of the respective locations.

In operation 416, the location of the dispense head 60 may be adjusted or modified by the x-positional difference LX and/or the y-positional difference LW to eliminate or minimize the offset. For example, the location of the dispense head 60 may be modified such that the center of the dispense head 60 lies at the point (Phead₀±ΔX, Phead₁±ΔY).

In operation 418, the dispense head 60 may re-dispense another version of the drop pattern 500 on the substrate 12. For example, the dispense head 60 placed at location (Phead₀±ΔX, Phead₁±ΔY) may re-deposit the drop pattern 500 on the substrate 12. In the alternative, or in addition, the dispense head 60 can be placed elsewhere with the processor 54 adjusting which nozzles 64 it fires to dispense the drop pattern 500 despite the off-center placement of the dispense head 60.

In operation 420, the results of the re-positioning of the dispense head 60 may be evaluated using the vision system 70 (see FIG. 4). Further, drops 66 may again be dispensed using the methods described herein to obtain the dispense head 60 center, the substrate 12 center, the x-positional difference ΔX, and the y-positional difference ΔY. If the location of the as-deposited drop pattern 500 relative to the substrate 12 is acceptable to the user (i.e., within a threshold distance from a targeted area), method 400 can end if desired. If, however, the as-deposited drop pattern 500 is determined to be in a location not desired by the user, method 400 may be repeated until the dispense head 60 position is acceptable to the user.

In some embodiments the coordinates (Pdisk₀, Pdisk₁) of the center (or other reference point) of the substrate 12 may be determined using three points on the outer annular region 73 of substrate 12. In the alternative, or in addition, a reference point associated with the dispense head 60 other than its center may be used to characterize the location of the dispense head 60 relative to the substrate 12.

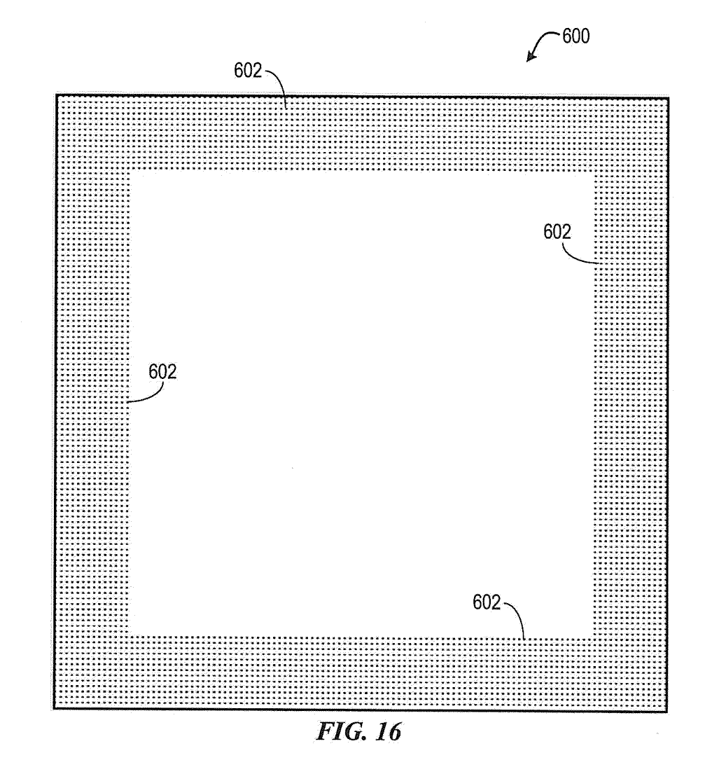

Thus, various portions of methods 200 and 400 allow the fluid dispense system 32 to be set up and characterized. For instance, FIGS. 16-25 illustrate the characterization of other aspects of the lithographic system 10.

### Characterization and Adjustment of Other Aspects of the Fluid Dispensing System

Other aspects of lithographic systems 10 (which might influence the quality of imprints produced thereby during production) can be characterized and adjusted. For instance, with reference now to FIGS. 1, 16, and 17, the fluid dispense system 32 may be used to deposit drops 66 on the substrate 12 in a pre-determined drop pattern 500 having one or more drop locations to create a plot diagram for use in these characterizations. The drop pattern 600 illustrated by FIG. 16 is but one of numerous drop patterns and represents a drop pattern selected to characterize aspects of the lithographic system 10 and, more particularly, the fluid dispense system 32. As such, as-dispensed drops 66 that are extra or missing, and/or drops 66 having a volume, diameter, size, location, and/or the like, different than that of the selected drop pattern 600 are sometimes not desired by some users. For instance, an as-dispensed volume other than the selected volume for one or more drops 66 may result in extrusions, void defects, non-uniform thickness t₂ (see FIG. 2) of residual layer 48, and/or the like.

To characterize aspects of the fluid dispense system 32 which might be related to such situations, the drops 66 dispensed while attempting to create the selected drop pattern 600 may be analyzed to quantify the placement and size of the as-dispensed drops 66. The resulting quantitative data may be used to alter subsequent drop patterns dispensed on the substrate 12 to reduce the number and size of extrusions and void defects in the resulting patterned layer 46. In addition, or in the alternative, the data may be used to provide a uniform thickness t₂ of the residual layer 48 depending on user desires, considerations for objects produced by the lithographic system 10, etc. Further, the data may be used in preventative maintenance schemes to maintain yields for production of patterned layers 46 (in manufacturing environments) and/or for other purposes.

Referring now to 17, the defect analysis tool 68 (see FIG. 4) may provide an image 604 on a graphical user interface 605 of the drops 66 on the substrate 12. Moreover, the drops 66 may be dispensed on the substrate 12 and solidified prior to obtaining the image 604. Thus, the image 604 may provide information regarding the as-dispensed location of the drops 66, the as-dispensed size of the drops 66, and/or the like. The memory 56 may store threshold values for one or more parameters for comparison to the information regarding the as-dispensed drops 66. For example, the memory 56 may store thresholds for contrast values, size values, shape values, aspect ratio values, drop perimeter lengths, drop circularity, and/or the like. The information obtained by the sensor 88 can provide as-dispensed locations (for instance, x-y coordinates) for each drop 66. Using the information in the image 604, a plot diagram 606 of the as-dispensed locations of each drop 66 may be developed and/or compiled and stored in memory 56 as a data file (for instance, as a text file, a comma delimited file, etc.).

### Registration of As-Dispensed and Selected Drop Patterns

Referring now to FIG. 19, the plot diagram 606 of the as-dispensed drops 66 may be aligned to, or registered with, the selected drop pattern 600 to characterize aspects of the fluid dispense system 32. More specifically, the plot diagram 606 may be X, Y and θ registered with the selected drop pattern 600. For instance, two specific drop locations 610a and 610b in the plot diagram 606 may be aligned with the locations of two corresponding as-dispensed drops 602a and 602b in the selected drop pattern 600 to bring the plot diagram 606 into registration with the selected drop pattern 600.

The plot diagram 606 (or an image thereof) may be manually (or mathematically) rotated and shifted to register the locations of the as dispensed drops 66 with the desired locations of the corresponding drops 602a and 602b. FIGS. 19A and 19B illustrated these locations being registered with one another wherein the plot diagram 606 is rotated through an angle f to register with the selected drop pattern 600. Moreover, the plot diagram 606 might also be translated through some displacement (in the x and/or y-directions) to register the plot diagram 606 with the selected drop pattern 600 although (for the sake of clarity) such translations are not illustrated. Furthermore, although FIGS. 19A and 19B illustrate the as-dispensed drop locations 610a and 610b and the locations of the drops 602a and 602b near certain edges of the plot diagram 606 and the selected drop pattern 600, other locations can be used to register the plot diagram 606 with the desired drop pattern 600. In embodiments where an image of the plot diagram 606 is registered with the selected drop pattern 600, a least-squares analysis or other mathematical algorithm can be used to perform the registration.

### Characterizing and Adjusting for Missing, Extra, and Mis-Located Drops

Referring to FIGS. 16, 18, and 20, the selected locations of the drops in the selected drop pattern 600 may be compared to the locations of the as-dispensed drops 66 of the plot diagram 606 to characterize the as-dispensed drops 66. The resulting characterization of the as-dispensed drop pattern can be used to adjust the performance of the fluid dispense system 32 (i.e., the lithographic system 10) and improve the consistency between the selected and as-dispensed drop locations thereby improving the imprints produced by the lithographic system 10.

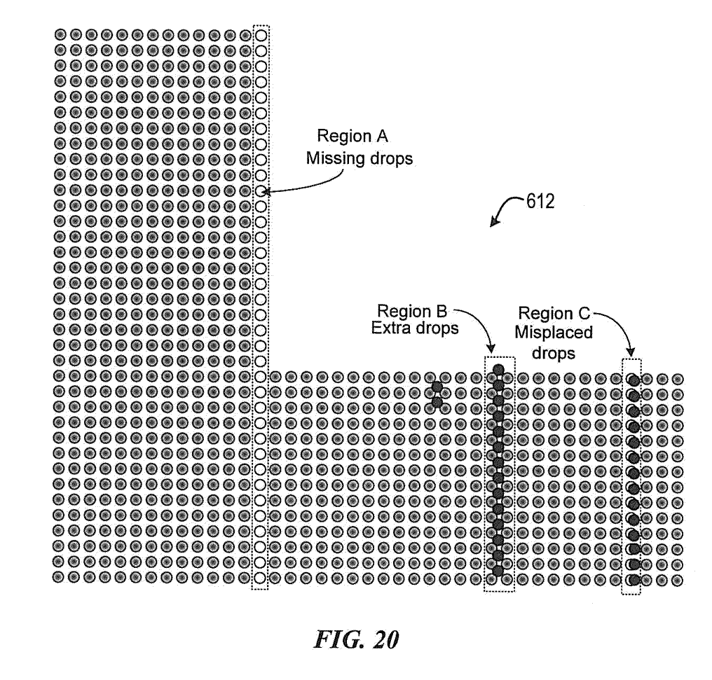

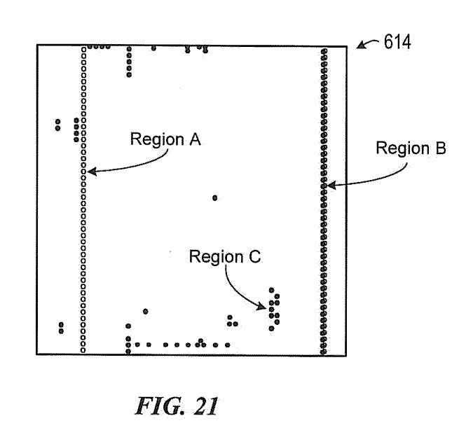

For instance, a “die-to-database” comparison of the selected drop pattern 600 and the plot diagram 606 may be performed. The desired locations of the drops may be correlated to the locations of the as-dispensed drops as reflected in the plot diagram 612 of FIG. 20. The correlation may identify any selected drop locations which have no as-dispensed drops 66 in the corresponding locations in the plot diagram 612 (illustrated as region A of FIG. 20). The correlations may also identify any as-dispensed locations in the plot diagram 612 which have no drops in the corresponding locations in the selected drop pattern 600 (illustrated as region B of FIG. 20). In addition, or in the alternative, the correlation can identify as-dispensed locations reflected in the plot diagram 612 mis-located from the corresponding selected drop locations in the selected drop pattern 600 (illustrated as region C of FIG. 20).

Furthermore, FIG. 21 illustrates another plot diagram 614 which summarizes the foregoing results of the characterization of the foregoing aspects of fluid dispense system 32. Thus, with information pertaining to missing, extra, and mis-located drops, the lithographic system 10 (and, more particularly, the dispense heads 60, dispense systems 62, and nozzles 64 and/or their manner of their use) may be adjusted to compensate for such missing, extra, or mis-located drops.

### Characterizing and Adjusting for Placement Accuracy

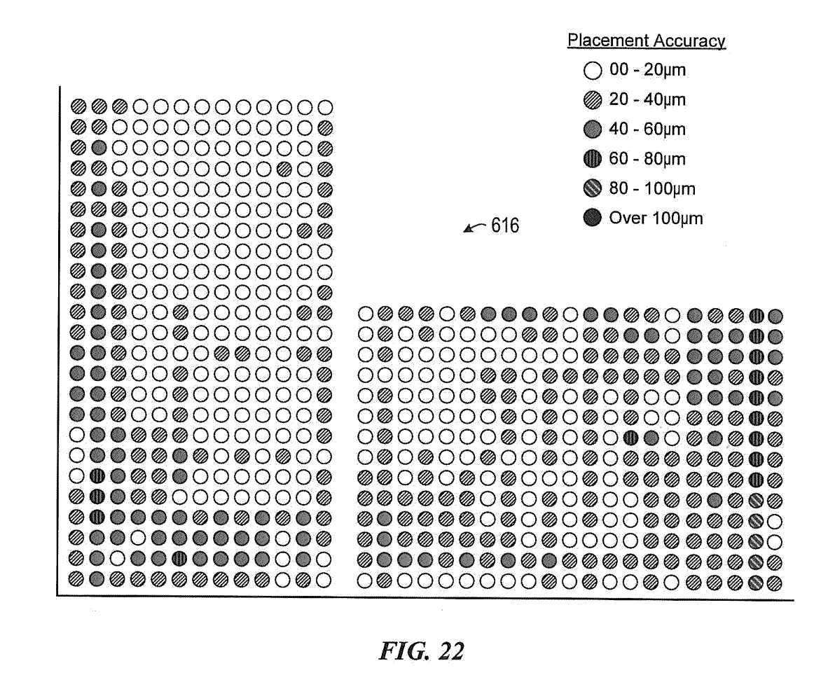

Furthermore, for mis-located drops, the as-dispensed locations reflected in the plot diagram 614 may be further characterized to determine placement error values for the locations of each as-dispensed drop 66. Thus, the accuracy of the drop-placements can be characterized. For example, some as-dispensed locations may be located within at least 20 μm of the corresponding as-desired locations. FIG. 22 illustrates another plot diagram 616 which incorporates placement error classifications. Moreover, placement error classifications may be identified in intervals as illustrated in FIG. 22. For instance, as-dispensed locations having approximately 20 μm to 40 μm placement accuracy may be defined as one interval, dispense locations having approximately 40 μm to 500 μm placement accuracy may be defined as other intervals in 20 μm increments as illustrated by FIG. 22. The foregoing placement accuracy classifications are non-limiting and other increments and other classification schemes may be used without departing from the disclosure. Nonetheless, the placement accuracy characterizations may be used to adjust the lithographic system 10.

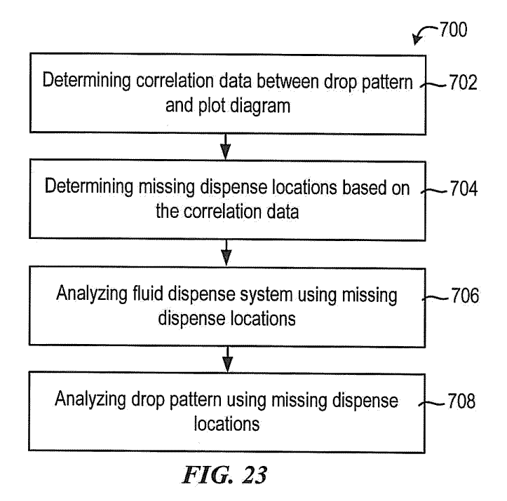

FIG. 23 illustrates a method 700 for adjusting the lithographic system 10 to account for any missing, extra, or mis-located drops. In operation 702, correlation data between the selected drop pattern 600 and the as-dispensed locations reflected in the plot diagrams 612, 614, or 616 may be determined. In operation 704, missing as-dispensed locations may be determined based on the correlation data. In operation 706, the fluid dispense system 32 may be analyzed using the missing as-dispensed locations to determine whether the hardware in the fluid dispense system 32 (for instance, the dispense heads 60 or nozzles 64) can be adjusted to provide drops 66 at the missing locations. More particularly, in operation 708, the as-dispensed drop pattern as reflected in the plot diagram 612, 614, or 616 may be analyzed to determine whether additional drops 66 may be dispensed at the missing locations. The addition of drops 66 and an increased accuracy in the placement of the additional drops 66 might improve the consistency between the as-dispensed drop pattern and the selected drop pattern 600.

### Performance Specifications

As disclosed herein, the lithographic system 10 (including the fluid dispense system 32) may be used to create imprinted patterns upon various substrates 12. Thus, the performance of the fluid dispense system 32 contributes to the imprinted patterns. In some embodiments, a performance specification and a corresponding drop pattern 600 are developed to direct the operation of the fluid dispense system 32 during the dispensing of drop patterns on particular substrates. Thus, the drop pattern 600 is selected to characterize the lithographic system 10 with regard to various features of lithographic imprints for which the performance specification provides the performance parameters.

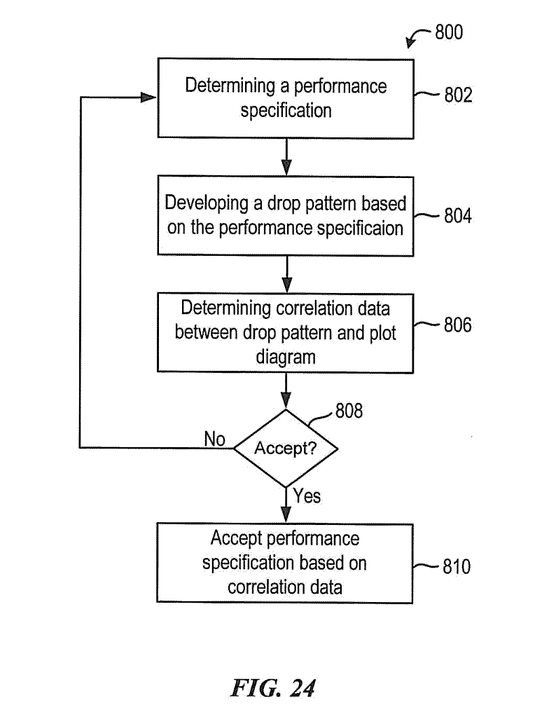

FIG. 24 illustrates an exemplary method 800 for establishing performance specifications (including selected performance parameters and thresholds therefore) for lithographic systems 10. In operation 802, an initial performance specification may be determined. For instance, one parameter in the performance specification may be a pre-determined magnitude for the thickness t₂ of residual layer 48 (see FIG. 2). In operation 804, an initial drop pattern 500 may be developed with the goal of providing imprints possessing the parameters of the pre-determined performance specification (for instance, the thickness t₂) following the hardening of the residual layer 48.

A drop pattern may be dispensed on the substrate 12 in an attempt to create the selected drop pattern 600. As the fluid dispense system 32 dispenses the as-dispensed pattern certain drops 66 might not be dispensed, certain extra drops 66 might be dispensed, some dispensed drops 66 might be mis-located, some dispensed drops 66 might be under/over sized, etc. Thus, the as-dispensed drop pattern might correlate to the selected drop pattern 600 in some aspects and might correlate to a lesser degree in other aspects.

In operation 806, the as-dispensed drop pattern can be characterized relative to the selected drop pattern 600 to obtain correlation data between the same. For instance, plot diagrams 606, 612, 614, and 616 and the underlying data may be determined. Furthermore, the plot diagrams 606, 612, 614, and 616 can be analyzed to determine whether the as-dispensed drop pattern meets the performance specification.

In addition, or in the alternative, the residual layer 48 (see FIG. 2) can be created from the as-dispensed drop pattern 506 and hardened to form an imprint on the substrate 12. In some embodiments the resulting imprint can be inspected to determine whether it meets or exceeds the performance specification and the performance parameters therein.

If the plot diagrams and/or the imprint meet the performance specification, as illustrated at operation 808, the selected drop pattern 506 and the performance specification may be accepted based on the correlation data. See operation 810. If not, operation 808 illustrates that method 800 may be repeated to iterate the selected drop pattern 600 and the performance specification as desired.

### Method of Manufacturing an Imprint

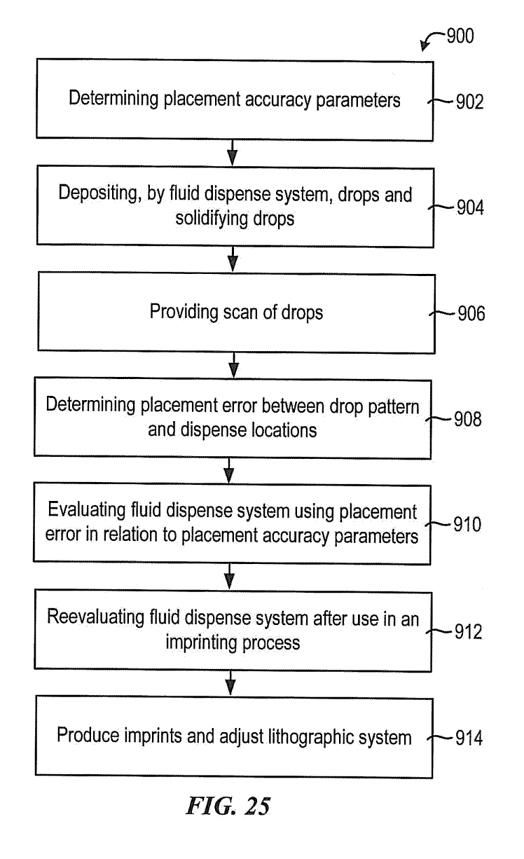

FIG. 25 illustrates a method 900 for manufacturing an imprint which includes characterizing a lithographic system 10. In operation 902, a drop pattern 600 including placement accuracy parameters may be selected (for instance, a placement accuracy between 0 μm±40 μm may be selected). In operation 904, the lithographic system 10 may deposit and solidify drops 66 on substrate 12. In operation 906, an image may be captured of the as-dispensed drop pattern and plot diagrams 606, 612, 614, and 616 may be determined. In operation 908, placement accuracies between the as-dispensed drops 66 and the desired drop pattern 600 may be analyzed using the plot diagrams 612, 614, and 616. In operation 910, the lithographic system 10 may be evaluated and adjusted using the placement accuracy information and/or other information in the plot diagrams 612, 614, and 616.

In operation 912, the adjusted lithographic system 10 can be used to dispense another version of the drop pattern 600. These subsequent, as-dispensed, drop patterns can be evaluated and developed into an imprint which may also be evaluated to characterize the lithographic system 10. See operation 912.

In operation 914, the fluid dispense system 32 may be adjusted again after use (and perhaps during production) based on the data developed during the foregoing characterization method 900. For instance, preventative maintenance and/or replacement of components within the fluid dispense system 32 may occur to ensure or improve process yields or for other reasons.

Thus, systems and methods have been disclosed which correlate as-dispensed drop patterns with drop patterns selected to characterize lithographic systems and, more particularly, fluid dispensing systems thereof. More particularly, lithographic systems can be characterized by techniques and technologies disclosed herein to determine drop size, drop shape, drop placement, etc. data. As a result, the quality and quantity of imprints produced using lithographic systems characterized as disclosed herein can be increased. Furthermore, the time, resources, and manpower used to install, set-up, and maintain lithographic systems can be reduced while maintaining or improving the quality and quantity of the imprints produced thereby.

What is claimed is:

1. A method comprising:
associating a selected pattern of drops with a particular dispense head, each nozzle of the particular dispense head being controllable to dispense a drop, the selected pattern having a selected orientation, each drop of the selected pattern having a selected location and size;
attempting to dispense the selected pattern on a substrate by controlling the nozzles to dispense a first pattern of drops, the first as-dispensed pattern having a first as-dispensed orientation, each as-dispensed drop having a first as-dispensed location and size;
relative to the selected pattern, characterizing the first as-dispensed pattern; and
associating, with the particular dispense head, the characterization of the first as-dispensed pattern relative to the selected pattern, the selected pattern having been selected to characterize the particular dispense head.

2. The method of claim 1 wherein the characterizing of the first as-dispensed pattern includes determining the first as-dispensed orientation.

3. The method of claim 1 wherein the characterizing of the first as-dispensed pattern includes determining whether each nozzle dispensed a drop according to how it was controlled during the dispensing of the first as-dispensed pattern.

4. The method of claim 1 wherein the characterizing of the first as-dispensed pattern includes determining the as-dispensed sizes of the as-dispensed drops.

5. The method of claim 1 wherein the characterizing of the first as-dispensed pattern includes determining whether any of the as-dispensed locations are farther from the corresponding selected locations by more than a corresponding threshold distance.

6. The method of claim 5 wherein the characterizing of the first as-dispensed pattern further includes determining whether any of the as-dispensed locations which are farther from the corresponding selected locations by more than the corresponding threshold distances indicate timing issues between any two or more of the nozzles.

7. The method of claim 1 wherein the characterizing of the first as-dispensed pattern includes determining whether any two as-dispensed locations indicate the presence of a reverse pass offset greater than a corresponding threshold offset.

8. The method of claim 1 wherein the characterizing of the first as-dispensed pattern includes determining a position of the particular dispense head relative to the substrate on which the first as-dispensed pattern was dispensed.

9. The method of claim 1 wherein the characterizing of the first as-dispensed pattern includes determining whether a position of the particular dispense head is farther from a selected position associated with the selected pattern by more than a threshold distance.

10. The method of claim 1 further comprising:
dispensing a second pattern of drops;
characterizing a particular fluid dispensing system of which the particular dispense head is a portion; and
associating the characterization of the particular fluid dispensing system with the particular fluid dispensing system and the particular dispense head.

11. The method of claim 1 further comprising, responsive to the characterizing of the first as-dispensed pattern:
adjusting the particular dispense head;
dispensing a second pattern of drops on the substrate with the as-adjusted dispense head;
relative to the selected pattern, characterizing the second as-dispensed pattern; and
associating, with the particular dispense head, the characterization of the second as-dispensed pattern.

12. The method of claim 1 further comprising:
developing a plot diagram of a pattern of drops and based on a performance specification;
dispensing a second pattern of drops on a particular substrate;
relative to the plot diagram based on the performance specification, evaluating the second as-dispensed pattern; and
associating, with the particular dispense head, the evaluation of the second as-dispensed pattern relative to the plot diagram, the plot diagram having been developed to evaluate, the particular dispense head in use with the particular substrate.

13. The method of claim 11 wherein the evaluating of the second as-dispensed pattern includes correlating the second as-dispensed drops with the plot diagram.

14. The method of claim 11 wherein the evaluating of the second as-dispensed pattern occurs after the second as-dispensed pattern is solidified.

15. The method of claim 11 wherein the performance specification includes at least one thickness associated with the second as-dispensed pattern, wherein the evaluating of the second as-dispensed pattern includes correlating the second as-dispensed drop size of at least one drop with the thickness.

16. The method of claim 11 wherein the substrate is a wafer and the second as-dispensed pattern is used to form an imprinted layer on the wafer.

17. A computer readable storage media storing processor executable instructions which when executed by the processor cause the processor to perform a method comprising:
associating a selected pattern of drops with a particular dispense head, each nozzle of the particular dispense head being controllable to dispense a drop, the selected pattern having a selected orientation, each drop of the selected pattern having a selected location and size;
attempting to dispense the selected pattern by controlling the nozzles to dispense a first pattern of drops on a substrate, the first as-dispensed pattern having a first as-dispensed orientation, each as-dispensed drop having a first as-dispensed location and size;
relative to the selected pattern, characterizing the first as-dispensed pattern; and
associating, with the particular dispense head, the characterization of the first as-dispensed pattern relative to the selected pattern, the selected pattern having been selected to characterize the particular dispense head.

18. A system comprising:
a vision system;
a processor in communication with the vision system; and
a memory in communication with the processor and storing processor executable instructions which when executed by the processor cause the processor to perform a process comprising:
associating a selected pattern of drops stored in the memory with a particular dispense head, each nozzle of the particular dispense head being controllable to dispense a drop, the selected pattern having a selected orientation, each drop of the selected pattern having a selected location and size;
attempting to dispense the selected pattern by dispensing a first pattern of drops on a substrate, the first as-dispensed pattern having a first as-dispensed orientation, each as-dispensed drop having a first as-dispensed location and size;
relative to the selected pattern, characterizing an image captured by the vision system of the first as-dispensed pattern; and
associating, with the particular dispense head, the characterization of the image of the first as-dispensed pattern relative to the selected pattern, the selected pattern having been selected to characterize the particular dispense head.

19. The system of claim 18 wherein the particular dispense head is a dispense head of an imprint lithography system.

20. The system of claim 18 further comprising a graphic user interface for displaying the characterization of the image of the first as-dispensed pattern.
